(19) United States
(12) Patent Application Publication
(10) Pub. No.: US 2017/0029054 A1
(43) Pub. Date: Feb. 2, 2017

(54) DEVICES AND METHODS FOR CONVERTING INTERNAL COMBUSTION ENGINES INTO HYBRID ELECTRIC ENGINES

(71) Applicant: SURYA CONVERSIONS LLC, Boulder, CO (US)

(72) Inventors: Joshua WOODWARD, Broomfield, CO (US); Matthew MINKLER, Longmont, CO (US); Irfan NADIADI, Superior, CO (US)

(21) Appl. No.: 15/224,031

(22) Filed: Jul. 29, 2016

Related U.S. Application Data
(60) Provisional application No. 62/199,106, filed on Jul. 30, 2015.

(51) Int. Cl. B62D 65/04; B60K 6/40; B60W 10/08; B60W 20/20; B60W 10/06

(52) U.S. Cl. CPC B62D 65/04; B60W 20/20; B60W 10/06; B60W 10/08; B60K 6/40; B60Y 2300/182; Y10S 903/951

(57) ABSTRACT

A hybrid electric vehicle retrofit kit provides an aftermarket solution to increase performance, fuel economy and/or reduce emissions. The retrofit kit includes an electric motor mechanically connected in a series configuration to a non-drivetrain side of an internal combustion engine. For example, the electric motor may be mechanically connected to a crankshaft of the internal combustion engine.

### CROSS-REFERENCE TO RELATED APPLICATIONS

This application claims the benefit of and priority to U.S. Provisional Patent Application No. 62/199,106, filed Jul. 30, 2015, which is hereby incorporated by reference in its entirety.

### BACKGROUND

To improve performance, increase fuel economy and reduce emissions from conventional internal combustion engines, hybrid electric vehicles have been developed that incorporate an electric motor in combination with an internal combustion engine. Such hybrid electric vehicles are classified according to whether the electric motor and internal combustion engine operate in parallel to provide power to the drivetrain through independent mechanisms, or operate in series, sharing a single assembly for power transfer, without a bypass option that allows for independent powering of the drivetrain. In either case, conversion of a vehicle to a hybrid electric vehicle tends to occur during manufacturing because the process typically involves significant alteration of the vehicle's drivetrain design. There are very few existing conversion kits that can be used to modify existing internal combustion engine vehicles. U.S. Patent Pub. No. US 2009/0223725, which is hereby incorporated by reference, describes one parallel hybrid electric vehicle conversion kit for a conventional internal combustion engine vehicle.

### SUMMARY

The present invention includes a conversion or retrofit kit for converting a conventional internal combustion engine vehicle into a hybrid electric engine. The conversion kit is an aftermarket product that increases performance, improves fuel economy and reduces emissions. The conversion kit may be used for rear wheel drive vehicles, four-wheel drive vehicles, heavy duty multi-axle vehicles and all-wheel drive vehicles, for example. In an embodiment, the vehicle may be a car, a motorcycle, an all-terrain vehicle, an auto-rickshaw, a snow machine, a train or any other vehicle having an internal combustion engine.

In an aspect, a hybrid electric vehicle retrofit kit comprises an electric motor mechanically connected in a series configuration to a non-drivetrain side of an internal combustion engine and a battery for exchanging energy with the electric motor.

In an embodiment, the electric motor is mechanically connected to a crankshaft of an internal combustion engine. In an embodiment, the electric motor may be mechanically connected to the crankshaft of the internal combustion engine via a crankshaft adapter having an extended driveshaft. For example, the extended driveshaft may have a length greater than four inches, or greater than 6 inches, or greater than 10 inches, or a length selected from a range of 4 inches to 20 inches, or 6 inches to 18 inches, or 8 inches to 16 inches, or 10 inches to 12 inches.

In some embodiments, the retrofit kit includes at least one sensor selected from an RPM sensor, a current sensor, a voltage sensor, a temperature sensor, a throttle position sensor, a brake position sensor, a clutch position sensor and any combination of these.

The retrofit kit may include a processor for receiving signals from at least one sensor and activating a main contactor to transfer electrical energy to or from the electric motor (see FIGS. 7-10).

In some embodiments, the retrofit kit further comprises a plug for connecting the battery to a power supply, such as a direct current (DC) or alternating current (AC) power supply.

In an embodiment, the retrofit kit disclosed herein may operate in a generating mode and/or a motoring mode, but the retrofit kit does not operate in an electric-only mode.

In an embodiment, the retrofit kit disclosed herein may operate in an electric-only mode.

In an embodiment, the internal combustion engine does not burn fuel during electric-only mode operation. For example, operation in the electric-only mode may comprise grounding a spark used to ignite fuel in the internal combustion engine, stopping fuel flow to the internal combustion engine or stopping fuel or air from passing over a carburetor of the internal combustion engine. In an embodiment, relief valves added to the crank case or air intake may block airflow into or out of the carburetor.

In an embodiment, the retrofit kit is installed on a vehicle having independent suspension. The wheel pairs (i.e., front wheels or back wheels) of an independent suspension vehicle are not connected by a solid axle. Rather, each wheel on an independent suspension vehicle has its own (half) axle and constant velocity (CV) joints that ensure the wheel is rotating at the same speed as its mate. The CV joints on the paired wheels are not collinear, so the wheels cannot be driven by a shared pulley or sprocket. A series hybrid configuration is well-suited to the independent suspension design because the series configuration allows the electric motor to deliver all power to the internal combustion engine instead of managing delivery of power to different axles or CV joints, thereby reducing mechanical and electrical complexity relative to a parallel hybrid system for an independent suspension vehicle where the electric motor must drive more than one axle.

In an aspect, a method of retrofitting a vehicle to a hybrid electric vehicle comprises mechanically connecting an electric motor in a series configuration to a non-drivetrain side of an internal combustion engine and providing a battery for exchanging energy with the electric motor.

In an embodiment, mechanically connecting the electric motor and the internal combustion engine includes installing a crankshaft adapter having a driveshaft.

In an embodiment, a method of retrofitting a vehicle to a hybrid electric vehicle further comprises providing a plug for connecting the battery to a power supply.

In an embodiment, a hybrid electric vehicle retrofit kit is an original engine or vehicle component, such as a factory-installed apparatus.

### BRIEF DESCRIPTION OF THE DRAWINGS

FIG. 1 shows a schematic of a conventional internal combustion engine vehicle (A) and a schematic of components mechanically connected to a crankshaft of an internal combustion engine (B).

FIG. 2 shows a schematic of a conventional hybrid electric vehicle.

FIG. 3 shows a schematic of a hybrid electric vehicle equipped with a retrofit hybrid conversion kit, according to an embodiment.

FIG. 4 shows engineering drawings for a crankshaft adapter, according to an embodiment.

FIG. 5 shows a schematic of an electric motor mechanically connected to a crankshaft of an internal combustion engine, according to an embodiment.

FIG. 6 shows a drive cycle as a graph of time versus speed with acceleration periods circled.

FIG. 7 shows a flow diagram for a processor that manages energy flow to and from an electric motor.

FIG. 8 shows a flow diagram for a processor that manages energy flow to and from an electric motor.

FIG. 9 shows a flow diagram for a processor that monitors throttle position and manages energy flow to and from an electric motor.

FIG. 10 shows a flow diagram for a processor that monitors brake position and manages energy flow to and from an electric motor.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

An “apparatus” is a combination of components operably connected to produce one or more desired functions.

A “component” is used broadly to refer to an individual part of an apparatus.

The terms “direct and indirect” describe the actions or physical positions of one component relative to another component, or one apparatus relative to another apparatus. For example, a component that “directly” acts upon or touches another component does so without intervention from an intermediary. Contrarily, a component that “indirectly” acts upon or touches another component does so through an intermediary (e.g., a third component).

As used herein, the term “internal combustion engine” includes but is not limited to piston engines, positive displacement engines, inline engines, V-shaped engines, radial engines, rotary engines, combustion turbines, fuel cells and/or any other suitable motive device. Typical fuels for an internal combustion engine include, without limitation, hydrogen, natural gas, steam, gasoline, diesel, fuel oil, wood, coal, and/or any other suitable energy containing substance.

References to an “electric motor”, a motor-generator and the like, refer to suitable devices for converting between electrical energy and mechanical energy. Desirably, the electric motor receives electrical power (e.g., from a battery) to provide mechanical power and receives mechanical power (e.g., from a belt or pulley) to store as electric energy.

A “battery” may include any suitable device and/or apparatus for storing, containing, collecting and/or distributing electrical power and/or potential, such as, for example, capacitors, ultra-capacitors, lead acid cells, lithium metal ion cells, metal hydride packs and/or any other system that buffers and/or stores energy.

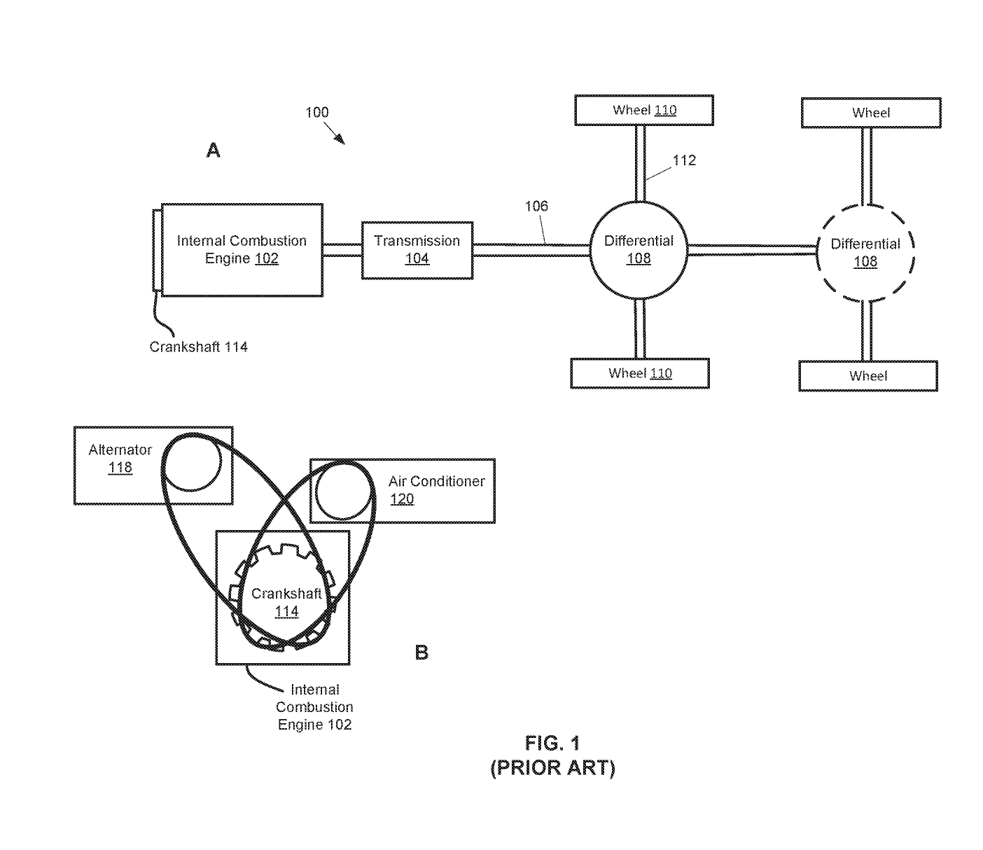

As shown in FIG. 1A, a conventional vehicle 100 has an internal combustion engine 102 located in the front of the vehicle with a transmission 104 transferring power to a driveshaft 106 extending to one or more differentials 108 for distributing power to the driven wheels 110 of the vehicle 100 through axles 112. A crankshaft 114 on the non-drivetrain side of the internal combustion engine 102 may provide power to auxiliary systems, such as a fan, an alternator 118 or an air conditioner 120, as shown in FIG. 1B. According to an embodiment, the transmission 104 includes automatic transmissions and/or manual transmissions. Manual transmissions typically, but not necessarily, include a transmission clutch mechanism.

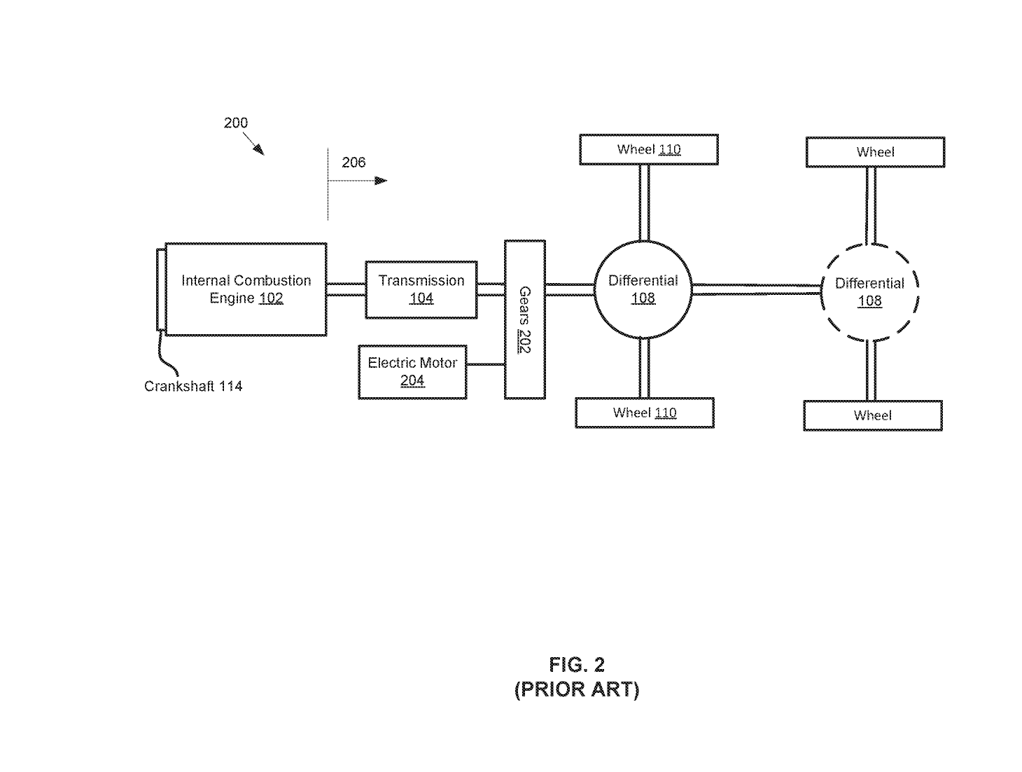

FIG. 2 shows a schematic of a conventional hybrid electric vehicle 200 having gears 202 and an electric motor 204 disposed on or coupled to a drivetrain side 206 of an internal combustion engine 102 between the transmission 104 and a differential 108. The electric motor 204 and the internal combustion engine 102 are arranged in a parallel configuration to simultaneously apply power to the drivetrain via independent mechanisms.

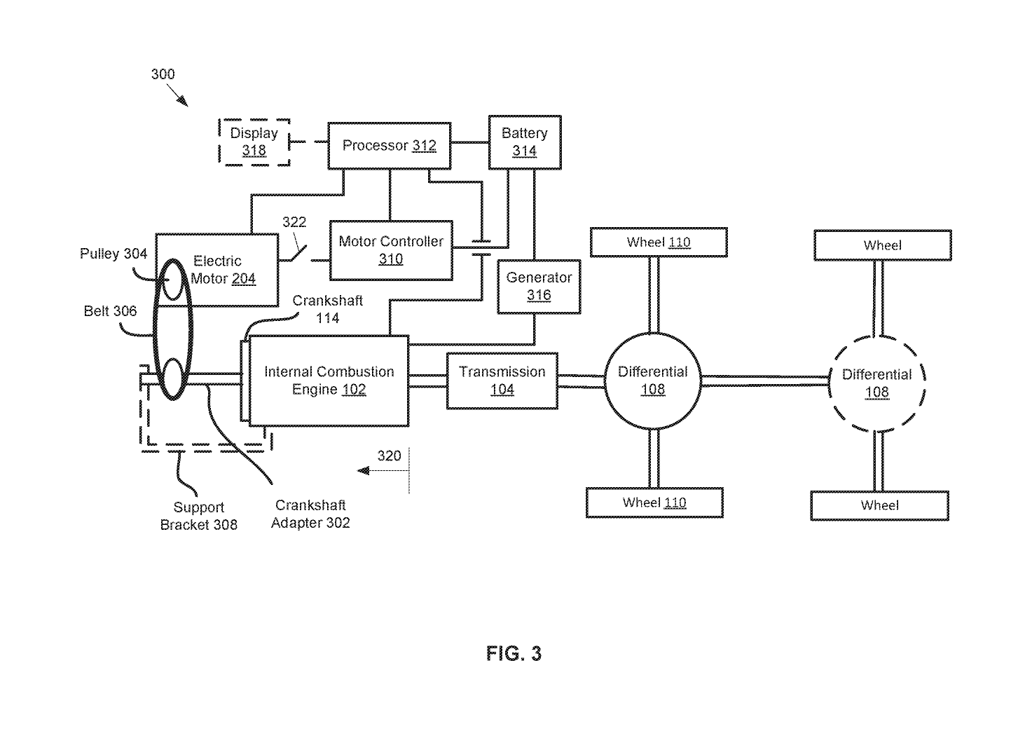

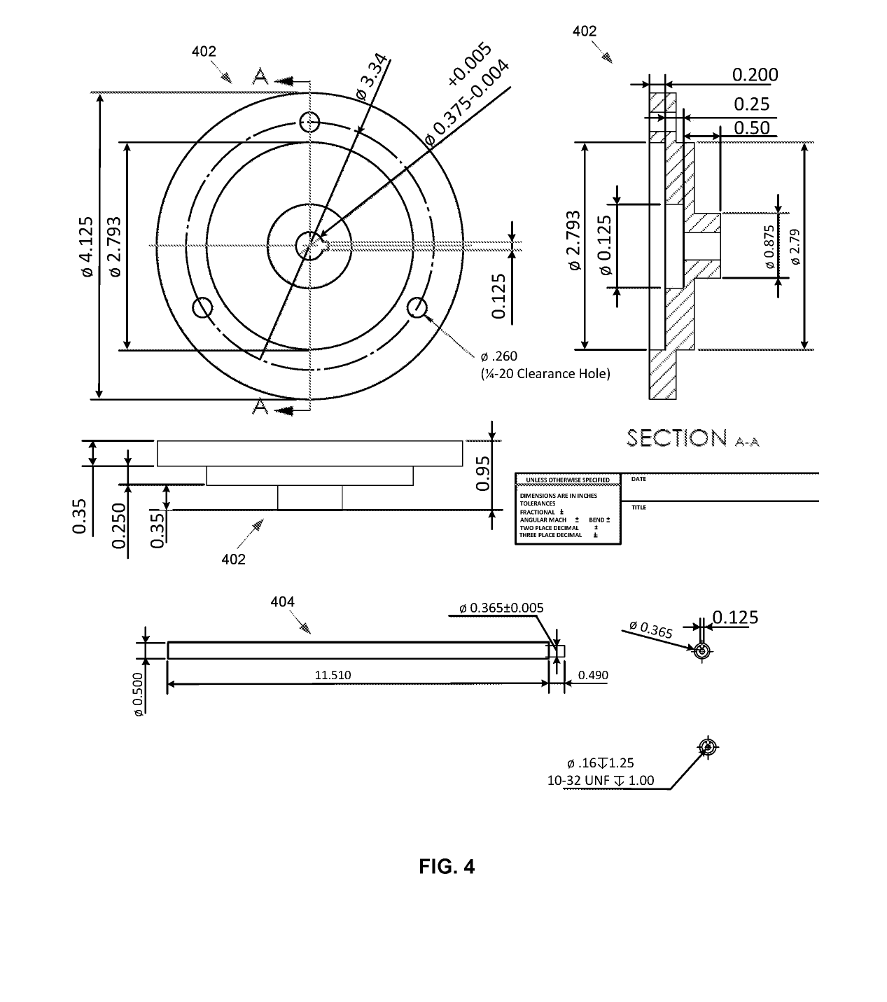

FIG. 3 shows a schematic of a hybrid electric vehicle 300 after installation and/or hybridization with a retrofit hybrid conversion kit, according to an embodiment where the retrofit hybrid conversion kit includes all components shown in FIG. 3 that are not shown in FIG. 1. The retrofit hybrid conversion kit includes a crankshaft adapter 302 comprising a flange 402 and a driveshaft 404, shown in greater detail in FIG. 4. The driveshaft 404 of the crankshaft adapter 302 mechanically connects to an electric motor 204, for example via pulleys 304 and a belt 306. An optional support bracket 308 mounted on the internal combustion engine 102 or another stationary component of the vehicle 300 may be used to support the driveshaft 404 of the crankshaft adapter 302. The electric motor 204 provides additional torque to the internal combustion engine 102 when instructed and/or commanded by a processor 312 and a motor controller 310. Processor 312 monitors sensors in one or more of the internal combustion engine 102, the electric motor 204, the motor controller 310 and a battery 314. Battery 314 receives electricity from generator 316, which converts mechanical energy from internal combustion engine 102 into electrical energy via electromagnetic induction. Processor 312 automates engaging and disengaging the electric motor 204, via main contactor/relay 322, during desired phases of the drive cycle. The electric motor 204 can operate in a motoring mode, a generating mode or an electric-only mode, depending on whether the vehicle is accelerating or braking. Optionally, the processor 312 reports sensor data, such as engine speed, battery capacity, battery charge and discharge rate and component temperatures on a display 318.

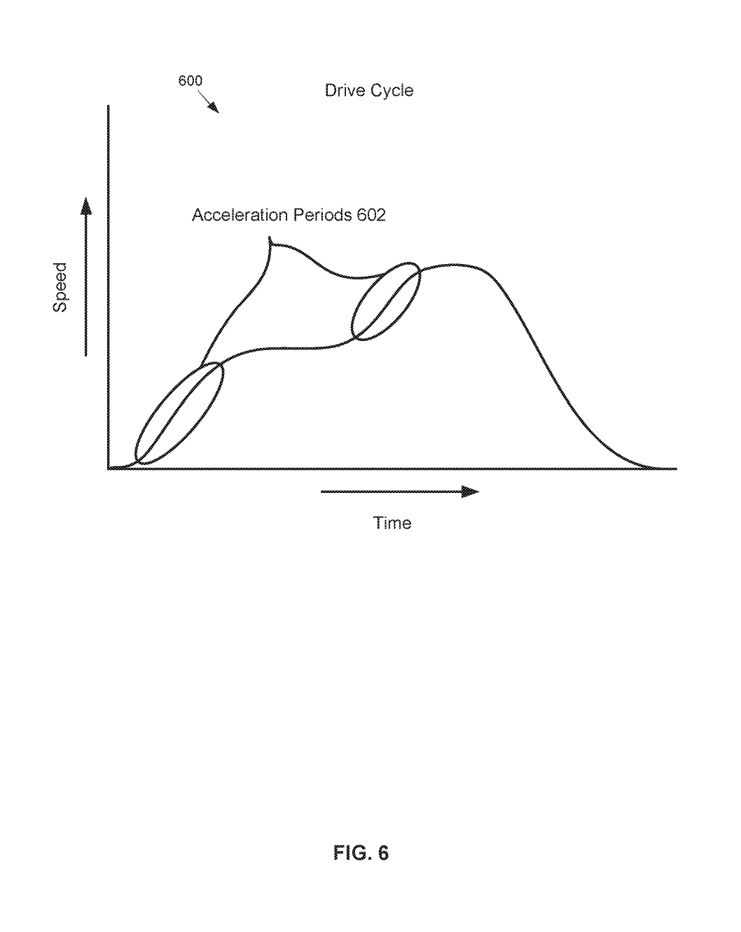

As shown in FIG. 3, the electric motor 204 is provided in a series configuration to assist the internal combustion engine 102 via a single, shared drive assembly, especially during acceleration periods 602, as shown in the drive cycle graph 600 of FIG. 6.

The retrofit approach, according to one embodiment, includes installing or connecting the electric motor 204 before and/or upstream of the internal combustion engine 102 and/or the transmission 104 on a non-drivetrain side 320 of the internal combustion engine, as shown in FIG. 3. Desirably, the internal combustion engine 102 and the transmission 104 remain unaltered to facilitate and/or simplify installation of the retrofit kit.

FIG. 6 depicts a graph 600 of time versus speed illustrating a vehicle starting from a complete stop, accelerating to a higher speed, maintaining speed for a period of time, accelerating a second time to a new speed, maintaining the new speed for a time, then decelerating to a complete stop. Although the electric motor 204 of a retrofit conversion kit may be used to assist the internal combustion engine 102 of a vehicle equipped with the kit during any one of these events, the largest performance enhancement is achieved when electric power from the electric motor 204 is converted into mechanical energy during the acceleration periods 602 that are circled on the graph 600.

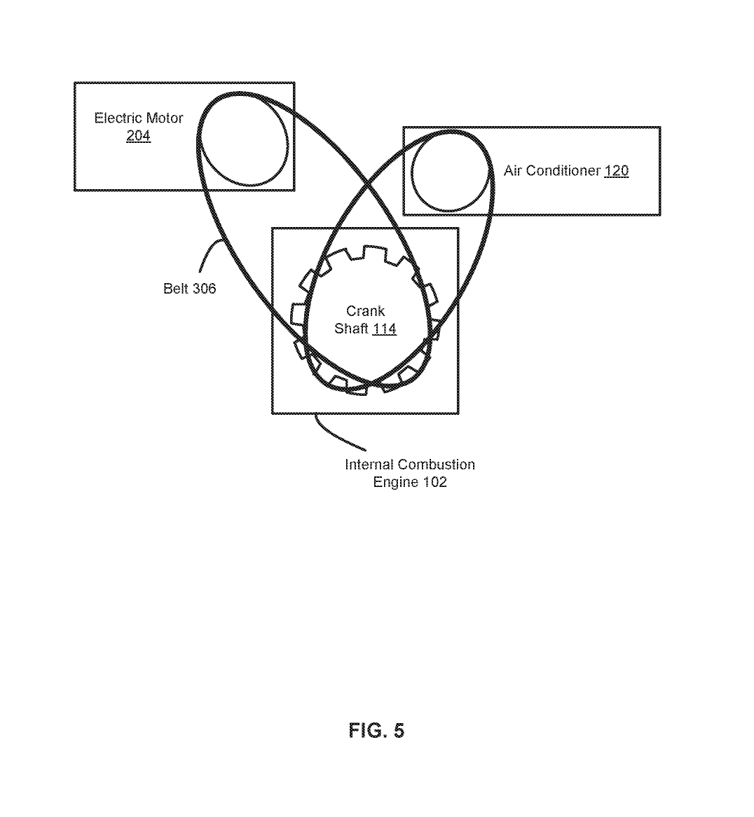

FIG. 5 shows a schematic of an electric motor 204 mechanically connected to a crankshaft 114 of an internal combustion engine 102, according to an embodiment. In this embodiment, a crankshaft adapter is not required. The electric motor 204, or a pulley of the electric motor 204, is connected directly to an existing crankshaft, for example via a belt 306. In an embodiment, an electric motor 204 may replace the alternator 118 shown in FIG. 1B. The electric motor 204 of FIG. 5 is also configured in series with an internal combustion engine 102 and controlled by a processor 312 and controller 310, as shown in FIG. 3.

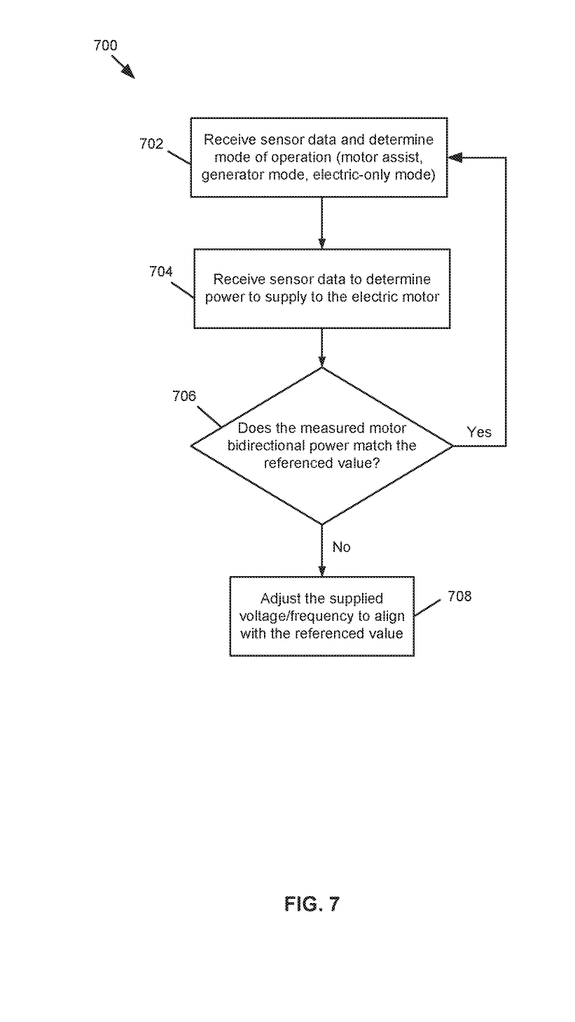

FIG. 7 shows a flow diagram or decision circuit 700 for a processor that manages energy flow to and from an electric motor. In step 702, the processor 312 receives sensor data and determines the mode of operation of the electric motor 204. For example, typical operating modes for the electric motor 204 may include generating mode (charging the battery with power from the internal combustion engine), motoring mode (powering the wheels from both the internal combustion engine and the electric motor) or electric-only mode (powering the wheels from the electric motor only). In step 704, the processor 312 receives sensor data and determines the power supply to the electric motor 204. Step 706 is a query to determine whether the measured bidirectional power matches the referenced value. If the values match, the processor 312 returns to steps 702 and 704 to continuously monitor the function of the electric motor 204. If the values do not match, the motor controller 310 adjusts the supplied voltage/frequency to align with the referenced value, in step 706.

According to an embodiment, the retrofit kit includes a processor 312 comprising machine-readable instructions for observing both the internal combustion engine 102 and the electric motor 204 and taking appropriate action in the form of torque commands for the electric motor 204, by using one-way communication with the internal combustion engine 102. For example, observing the engine performance (engine RPMs, shaft RPMs, vehicle speed, transmission gear, and the like) with no commands given to the internal combustion engine 102 from the processor 312.

Sensors for receiving signals from the vehicle, such as the internal combustion engine and/or the electric motor, include but are not limited to RPM sensors, current sensors, voltage sensors, throttle position sensors, brake position sensors, clutch position sensors and any combination of these. Signals provided to the processor from the sensors may be analog and/or digital signals.

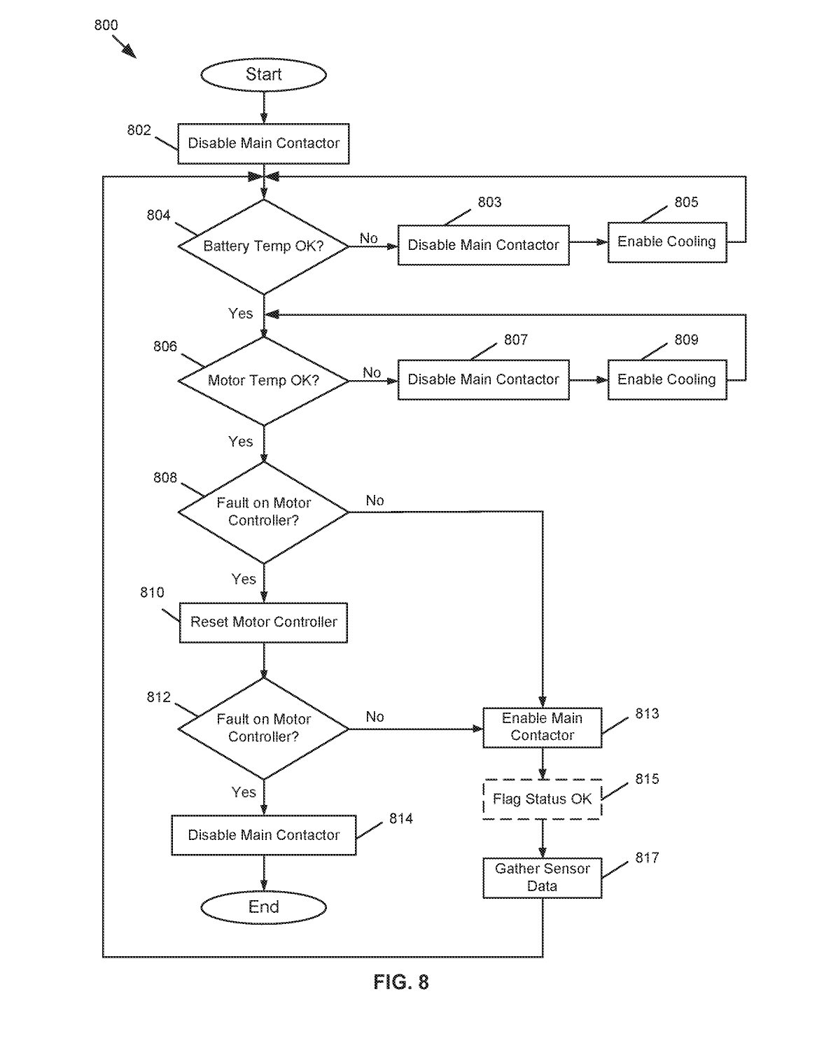

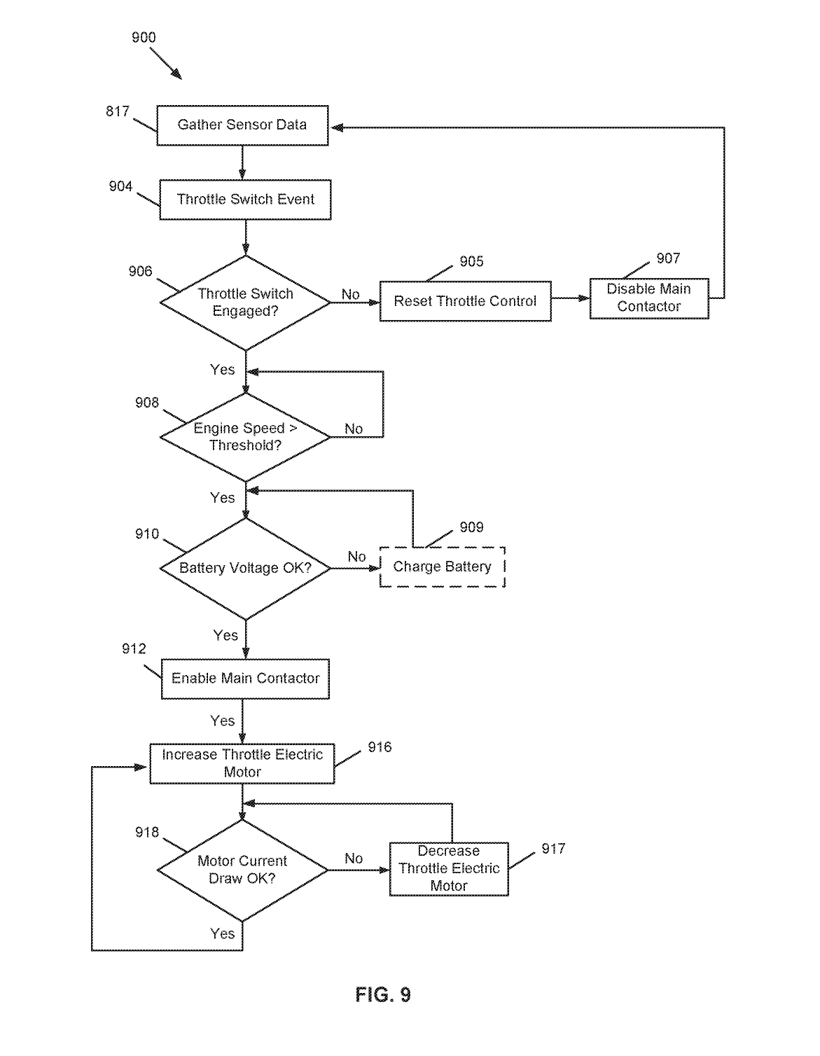

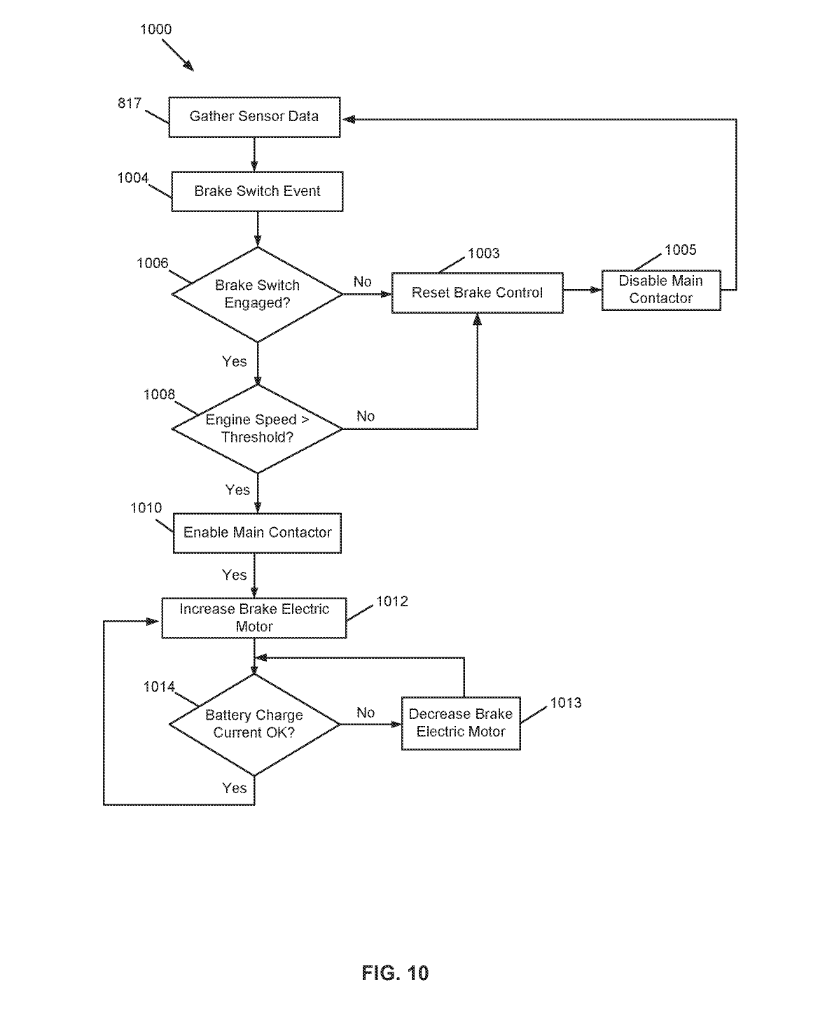

FIG. 8 shows a flow diagram 800 for a processor that manages energy flow to and from an electric motor. Upon ignition of the vehicle, the main contactor/relay (322, FIG. 3) is disabled in step 802. Step 804 is a query to determine whether battery temperature is within a safe range. For example, a temperature sensor in the battery may send data to the processor that compares the temperature with a programmed safe battery temperature range. If the battery temperature is not OK, i.e., within the safe range, the main contactor is disabled (step 803) and cooling is started (step 805). Cooling may be facilitated, for example, by a fan, fluid cooling system or electric cooling system. If the battery temperature is OK, the processor queries a motor temperature sensor (step 806) to determined whether the motor temperature is within a safe range. If the motor temperature is not within a safe range when compared with a programmed safe motor temperature range, the main contactor is disabled (step 807) and cooling is enabled (step 809). If the motor temperature is OK, the processor queries the motor controller to determine whether a fault has been detected in the motor controller (step 808). If a fault is detected, the motor controller is reset, in step 810, and the query is repeated to determine if a fault is detected on the motor controller, in step 812. If the fault continues to be detected, the main contactor is disabled and the vehicle must be serviced in order for the electric motor to be used to power the vehicle. The vehicle may still operate solely from the power supplied by the internal combustion engine. If no fault is detected on the motor controller, the main contactor is enabled, i.e., the relay switch is closed (step 813), the status is flagged as “OK” (optional step 815), and the processor gathers sensor data (step 817). The sensor data includes returning to steps 804, 806, 808, and optionally step 812, which may be performed in any order, but the sensor data may also include throttle or brake sensor data, as shown and described with reference to FIGS. 9 and 10.

FIG. 9 shows a flow diagram 900 for a processor that monitors throttle position and manages energy flow to and from an electric motor. As a continuation of step 817 of FIG. 8, the processor gathers sensor data. After a throttle switch event (step 904), such as a change in the throttle position sensor caused by acceleration or deceleration, the processor will detect the event by determining if the throttle switch is engaged (step 906). If the throttle switch is not engaged, the throttle control is reset (step 905) and the main contactor is disabled (step 907), which prevents the electric motor from powering the vehicle. If the throttle switch is engaged, the processor queries a RMP sensor measuring engine speed to determine whether the engine speed is greater than a threshold value (step 908). If the engine speed does not exceed a programmed threshold value, the engine speed is continually monitored until the engine comes up to speed. If the engine speed exceeds the threshold value, the processor determines whether the battery voltage is at or above a programmed value (step 910). If the battery voltage is too low, the battery may be charged (optional step 909) until it is “topped off”. If the battery voltage is within the programmed range, the main contactor is enabled (step 912), and the throttle of the electric motor may be increased (step 916). The processor monitors the motor current draw (step 918) and allows the electric motor throttle to be increased (step 916) as long as the motor current draw is below a programmed threshold level. If the motor current draw becomes too high, the electric motor throttle is decreased in step 917.

FIG. 10 shows a flow diagram 1000 for a processor that monitors brake position and manages energy flow to and from an electric motor. As a continuation of step 817 of FIG. 8, the processor gathers sensor data. After a brake switch event (step 1004), such as a change in the brake position sensor caused, for example, by depressing or releasing a brake pedal, the processor will detect the event by determining if the brake switch is engaged (step 1006). If the brake switch is not engaged, the brake control is reset (step 1003) and the main contactor is disabled (step 1005). If the brake switch is engaged, the processor queries a RPM sensor measuring engine speed to determine whether the engine speed is greater than a threshold value (step 1008). If the engine speed does not exceed a programmed threshold value, the brake control is reset (step 1003) and the main contactor is disabled (step 1005). If the engine speed exceeds the threshold value, the main contactor is enabled (step 1010), and braking of the electric motor is increased (step 1012), whereby mechanical braking energy is converted into electrical energy to charge the battery, which is known as regenerative braking. The processor monitors the battery charge current (step 1014) and allows the electric motor braking to be increased (step 1012) as long as the battery charge current is below a programmed threshold level. If the battery charge current becomes too high, the electric motor braking is decreased (step 1013).

Those of skill in the art will appreciate that suitable circuitry for electrically connecting the battery with the electric motor, such as, an inverter, a rectifier, a capacitor and/or any other power transforming component, may be incorporated into the retrofit conversion kit design. According to an embodiment, the retrofit conversion kit also provides plug-in hybrid electric functionality by including a plug for connecting to a direct current (DC) or alternating current (AC) power source.

Desirably, the retrofit conversion kit can be installed in a few hours resulting in a hybridized vehicle with minimal effect on the original internal combustion engine or the drivetrain. Desirably, the retrofit conversion kit may be disabled with a command from the processor and/or the driver, such as, under a fault condition, so the vehicle can be safely driven in conventional internal combustion engine mode.

The hybridized vehicle may include any suitable transportation device having wheels, treads, tracks, rails, propellers, impellers, and/or any other suitable motive apparatus. According to an embodiment, the hybridized vehicle may include rear wheel drive vehicles, four-wheel drive vehicles, heavy duty multiple-driven axle vehicles and/or all-wheel drive vehicles. All-wheel drive vehicles and/or four-wheel drive vehicles may include pail lime and full time systems, for example, manually controlled by the driver and/or automatically controlled by a computer.

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a wheel” includes a plurality of such wheels and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described. Nothing herein is to be construed as an admission that the invention is not entitled to antedate such disclosure by virtue of prior invention.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements, limitation or limitations which is/are not specifically disclosed herein.

All art-known functional equivalents of materials and methods are intended to be included in this disclosure. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed can be resorted to by those skilled in the art, and that such modifications and variations are considered to be within the scope of this invention as defined by the appended claims.

1. A hybrid electric vehicle retrofit kit, comprising:
an electric motor mechanically connected in a series configuration to a non-drivetrain side of an internal combustion engine; and
a battery for exchanging energy with the electric motor.

2. The retrofit kit of claim 1, wherein the electric motor is mechanically connected to a crankshaft of the internal combustion engine.

3. The retrofit kit of claim 2, wherein the electric motor is mechanically connected to a crankshaft adapter having an extended driveshaft.

4. The retrofit kit of claim 3, wherein the extended driveshaft has a length greater than 4 inches.

5. The retrofit kit of claim 3, wherein the extended driveshaft has a length selected from a range of 4 inches to 20 inches.

6. The retrofit kit of claim 1, further comprising at least one sensor selected from an RPM sensor, a current sensor, a voltage sensor, a temperature sensor, a throttle position sensor, a brake position sensor, a clutch position sensor and any combination of these.

7. The retrofit kit of claim 6, further comprising a processor for receiving signals from the at least one sensor and activating a main contactor to transfer electrical energy to or from the electric motor.

8. The retrofit kit of claim 1, further comprising a plug for connecting the battery to a power supply.

9. The retrofit kit of claim 1, wherein the retrofit kit operates in generating mode, motoring mode and electric-only mode.

10. The retrofit kit of claim 9, wherein the internal combustion engine does not burn fuel during the electric-only mode.

11. The retrofit kit of claim 9, wherein operation in the electric-only mode comprises grounding a spark used to ignite fuel in the internal combustion engine, stopping fuel flow to the internal combustion engine or stopping fuel or air from passing over a carburetor of the internal combustion engine.

12. The retrofit kit of claim 1, wherein the retrofit kit is installed in a vehicle having independent suspension.

13. A method of retrofitting a vehicle to a hybrid electric vehicle, the method comprising:
mechanically connecting an electric motor in a series configuration to a non-drivetrain side of an internal combustion engine; and
providing a battery for exchanging energy with the electric motor.

14. The method of claim 13, wherein mechanically connecting the electric motor and the internal combustion engine includes installing a crankshaft adapter having a driveshaft.

15. The method of claim 13, further comprising installing at least one sensor selected from an RPM sensor, a current sensor, a voltage sensor, a temperature sensor, a throttle position sensor, a brake position sensor, a clutch position sensor and any combination of these.

16. The method of claim 13, further comprising providing a plug for connecting the battery to a power supply.

17. The method of claim 13, wherein the retrofit kit operates in generating mode, motoring mode or electric-only mode.

18. The method of claim 17, wherein the internal combustion engine does not burn fuel during the electric-only mode operation.

19. The method of claim 17, wherein operation in the electric-only mode comprises grounding a spark used to ignite fuel in the internal combustion engine, stopping fuel flow to the internal combustion engine or stopping fuel or air from passing over a carburetor of the internal combustion engine.

20. The method of claim 13, wherein the vehicle has independent suspension.
